(19) United States
(12) Patent Application Publication
(10) Pub. No.: US 2003/0168201 A1
(43) Pub. Date: Sep. 11, 2003

(54) Heating,ventilating and/or air conditioning appliances

(76) Inventor: Nicolas Abouchaar, Bad Rodah (DE)

Correspondence Address: Liniak Berenato Longacre & White, 6550 Rock Spring Drive, Suite 240, Bethesda, MD, 20817, US

(21) Appl. No.: 10/258,859

(22) PCT Filed: Oct. 19, 2001
(86) PCT No.: PCT/FR01/03264

(30) Foreign Application Priority Data
Oct. 20, 2000 (DE) 100 52 134.7

(51) Int. Cl. B60H 3/00

(52) U.S. Cl. 165/42

(57) ABSTRACT

The invention concerns heating, ventilating and/or air conditioning appliances, in particular for a vehicle, having optionally an evaporator (10) and comprising a fan, a heat exchanger for heating and an additional heating device (14), wherein the additional heating device (14) can be supplied at least partly with air which has not passed through the heat exchanger for heating (2).

The present invention relates to a heating, ventilating and/or air conditioning appliance and in particular to a heating, ventilating and/or air conditioning appliance for a vehicle.

In the conventional way, such an appliance has a fan for conveying air through the appliance and then into the cabin of the vehicle. To heat the air, a heat exchanger for heating is usually provided, and this may, for example, be traversed by the fluid used for cooling the engine. In general, in this context, it is necessary to make a distinction between, on the one hand, fluidic control and, on the other hand, pneumatic control, controls known as hybrid controls also being known. If the vehicle also has an air conditioning function, there is also an optional evaporator provided, and this is usually mounted upstream of the heat exchanger for heating, from the point of view of the art of fluid mechanics.

In recent years, such appliances have additionally also been provided with an additional heating device, for example so as to be able to heat up the vehicle cabin more quickly at the time of setting off. Such additional heating appliances may be electric heating devices, combustion heating appliances and the like, it also being possible for thermal regulators with a change in state to be used. Usually, such an additional heating device is incorporated into such appliances jointly with the heat exchanger for heating which acts as a heating body, the additional heating device usually being mounted directly downstream of the heat exchanger for heating, from the point of view of the art of fluid mechanics.

Mounting the additional heating device directly downstream was, hitherto, considered to be particularly advantageous, especially when the additional heating device is equipped with what are known as positive temperature coefficient resistive elements. In general, the additional heating device is therefore used to heat up the air which is passed through the heat exchanger for heating, so as to meet the technical requirements for air conditioning in the vehicle cabin.

Known heating, ventilating and/or air conditioning appliances of this type do, however, as far as the additional heating device is concerned, exhibit considerable losses because, owing to the spatial proximity of the heat exchanger for heating and the additional heating device, the heat exchanger for heating is heated by a transfer of thermal radiation. The known appliances also have a relatively slow response mode, also significantly dependent on the interaction between the heat exchanger for heating and the additional heating device. Finally, it is necessary, in the known heating, ventilating and/or air conditioning appliances, to use considerable fan power, so as to be able to guide the air through the various air treatment devices, and it is desirable in this context to be able to heat the vehicle cabin with a low fan power.

The object of the present invention is therefore to provide a heating, ventilating and/or air conditioning appliance, particularly for a vehicle, which eliminates the aforementioned drawbacks. Another object of the present invention consists in providing a heating, ventilating and/or air conditioning appliance which, for a requirement of small bulk, allows multiple use and an improvement in efficiency in at least some operating modes

According to the invention, the above objects are achieved by a heating, ventilating and/or air conditioning appliance having the characteristics of claim 1, improvements to the appliance according to the invention being set out in the dependent claims.

In particular, the invention proposes a heating, ventilating and/or air conditioning appliance, particularly for a vehicle, optionally having an evaporator and comprising a fan, a heat exchanger for heating and an additional heating device, in which the additional heating device can be supplied at least partly with air which has not passed through the heat exchanger for heating. Because the invention allows the additional heating device to be supplied essentially with untreated air, or at least with air which has not passed through the heat exchanger for heating, it is possible, in the vehicle cabin, to guide air heated by the additional heating device, using low fan power. The appliance according to the invention thus makes it possible to have in the appliance, in addition to the usual airflow paths, other paths or at least partial airflow paths, in which the air is guided through the additional heating device, but not through the heat exchanger for heating, the customary airflow path through the heat exchanger for heating then through the additional heating device obviously also being possible. Another advantage lies in the fact that the additional heating device can be lighter in weight and/or smaller, because the requirements relating to the pressure drops to which it gives rise are less significant. Furthermore, with the concept of the invention with the existing means of controlling the air stream, it is possible to obtain a broader scope of operation if, for example, the control of the additional heating device is coupled to each of the air stream control means.

In one preferred embodiment, the additional heating device can be connected in parallel at least partly with respect to the heat exchanger for heating, from the point of view of the art of fluid mechanics. In other words, it is possible according to the invention to provide means of controlling the air stream in such a way that part or all of the air supplied by the fan is guided past the heat exchanger for heating and through at least one section of the additional heating device. Such a mode of operation is, for example, appropriate for a function of auxiliary heating incorporated into the appliance, because, for example, only the additional heating device, which may also supply satisfactory heating power, has the stream pass through it, which means that a pressure drop across the heat exchanger for heating does not take place. Furthermore, this form of embodiment is advantageous in that there are more possible temperature levels than there are in the customary series connection of the evaporator, the heat exchanger for heating and the additional heating device.

Advantageously, the additional heating device is mounted in parallel, from the point of view of the art of fluid mechanics, at least partly with respect to the heat exchanger for heating. In other words, the heat exchanger for heating and the additional heating device are arranged in such a way that the air can pass, as selected, simultaneously and/or successively through at least one respective section of the heat exchanger for heating and/or of the additional heating device.

In a preferred form of embodiment, the additional heating device can actually have at least sections traversed in essentially opposite directions. By virtue of this configuration, air can, for example, pass through a section of the additional heating device without having passed through the heat exchanger for heating, while another part of the air which has passed through the heat exchanger for heating can pass through another section, it also being possible for the air which may or may not have passed through the heat exchanger for heating to pass in a first direction through the additional heating device, it then also being possible for another part of this air to pass through the additional heating device in an opposite direction, so as to be heated still further there.

Advantageously, the additional heating device runs essentially parallel to the heat exchanger for heating or essentially which would become at right angles to the direction of flow established therein in the event of failure of the additional heating device. A parallel orientation may for example make it possible to form an essentially continuous overall surface consisting of the heat exchanger for heating and of the additional heating device, which has the air flow vector as its normal vector, a certain overlap of the heat exchanger for heating and of the additional heating device also being possible.

As an alternative to the parallel arrangement, the additional heating device may also run at right angles to the heat exchanger for heating or be provided essentially parallel to the direction of flow which would become established therein in the event of failure of the additional heating device. This arrangement for example makes it possible to have a hot air mixing zone between the heat exchanger for heating and the additional heating device, in which zone the respective air flows can mix optimally, whether this be using an additional means of controlling the air stream or by supplying this mixing chamber with air which has been cooled more or with fresh air.

In addition to the perpendicular and parallel relationships between the heat exchanger for heating and the additional heating device, it may also be advantageous to form the additional heating device and the heat exchanger for heating with a configuration essentially in the shape of a V, it being possible for a configuration essentially in the shape of an N to be produced particularly when there is an optional evaporator present, from the evaporator, the heat exchanger for heating and the additional heating device.

The arrangement essentially in the shape of a V between the heat exchanger for heating and the additional heating device makes it possible, in a particularly simple way, to represent the most diverse air paths, such as, for example, a first air path in which the air passes in succession through the heat exchanger for heating and then through the additional heating device; a path in which the air passes simultaneously or in parallel through the heat exchanger for heating and the additional heating device or at least part of the additional heating device; and air paths in which the air flows, as selected, through the heat exchanger for heating or part of the additional heating device, combinations of the various airflow paths obviously also being possible.

In the configuration in the shape of an N formed by the arrangement of the evaporator, the heat exchanger for heating and the additional heating device, it is possible, in addition to passing the air through all the air treatment devices in an S shape, for the air to be removed or routed each time between two branches, so as to correspondingly bypass one or more of the air treatment devices.

In another preferred form of embodiment, the additional heating device is mounted so that it can move in the appliance, particularly so that it can pivot between an arrangement essentially parallel and an arrangement essentially at right angles to the heat exchanger for heating, or with respect to the air flow at the additional heating device. The pivoting configuration of the additional heating device may thus make it possible, on the one hand, to arrange the additional heating device in the path of the air only when needed, whereas it causes practically no resistance to flow when it is not in use and, on the other hand, the pivoting allows different operating modes to be employed. For this, the additional heating device could also be provided with a curved or bent shape, so as to further improve the flow properties.

Apart from being mounted so that it can pivot, the additional heating device can obviously also be mounted so that it can be offset or so that it can undergo a combined offsetting and pivoting movement. In the case of a simple offsetting movement, it is, for example, possible to vary the proportion of the additional heating device through which the air which has not passed through the heat exchanger for heating can pass.

Finally, it is preferable for the additional heating device to be an electric heating device, particularly a device comprising at least one PTC heating element. In each case, it is possible to use the additional heating device for the dedicated heating of what may be a special purpose outlet, for example to be able to heat dishes or beverages. Other advantages and characteristics of the invention will become further apparent from the following description, given merely by way of example, of some currently preferred forms of embodiment and which refers to the accompanying drawings in which:

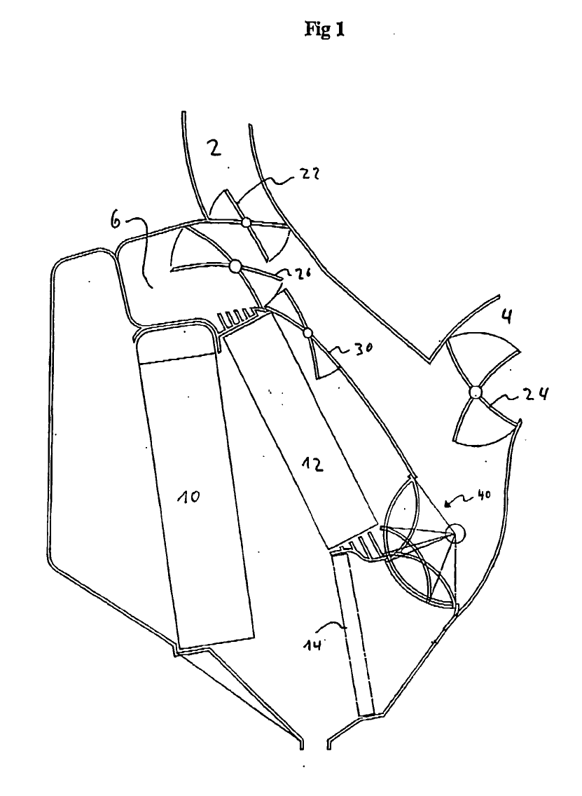

FIG. 1 illustrates, in schematic section, a first preferred form of embodiment in the heating, ventilating and/or air conditioning appliance according to the invention;

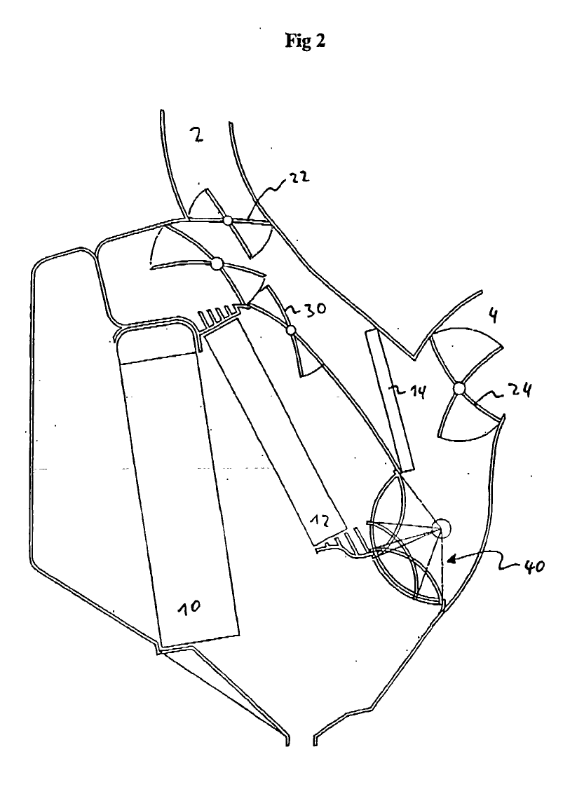

FIG. 2 illustrates an alternative form of embodiment;

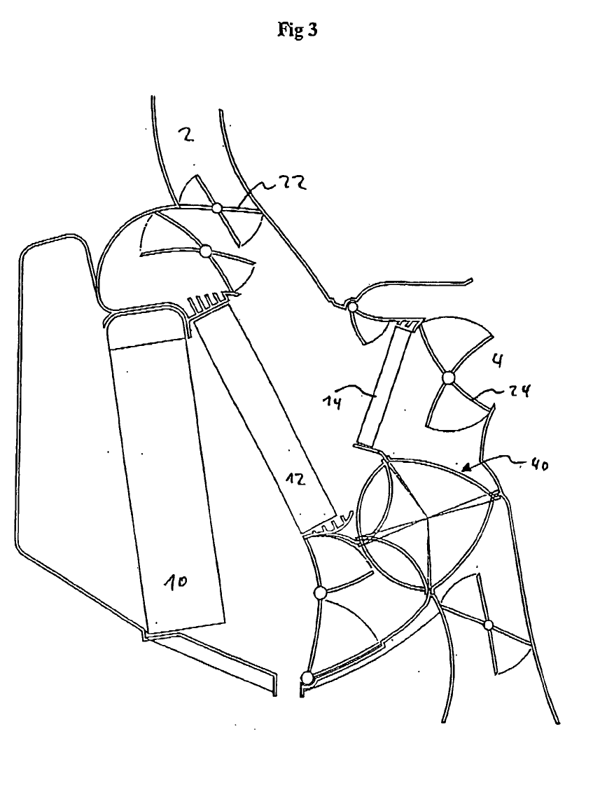

FIG. 3 illustrates an improvement to the form of embodiment illustrated in FIG. 2;

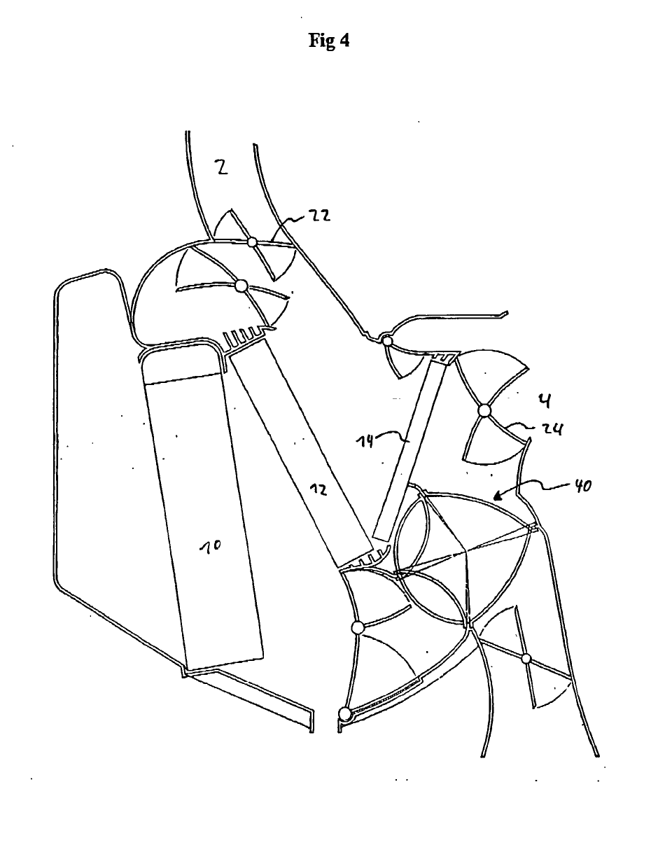

FIG. 4 illustrates yet another improvement to the forms of embodiment illustrated in FIGS. 2 and 3;

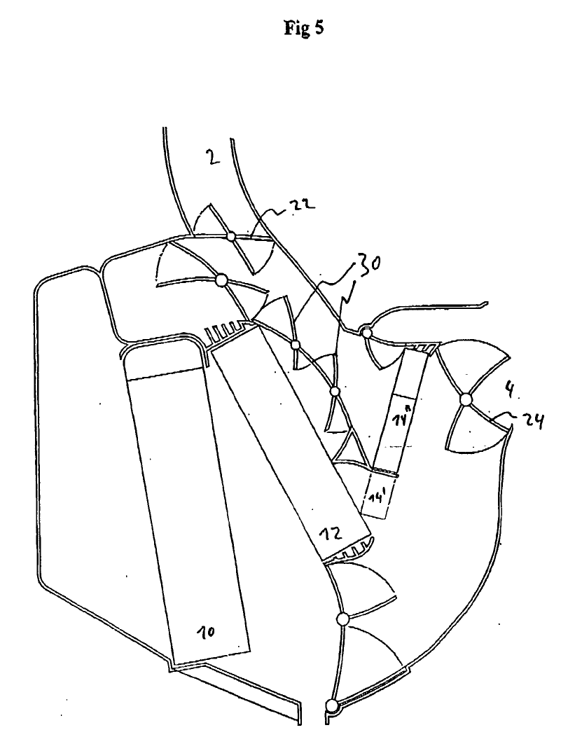

FIG. 5 illustrates yet another form of embodiment of a heating, ventilating and/or air conditioning appliance according to the invention and in schematic section;

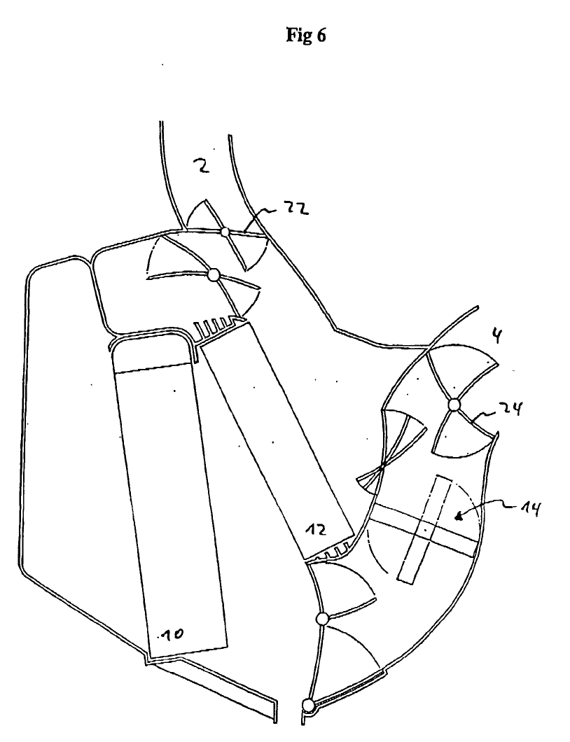

FIGS. 6 to 8 illustrate other preferred alternative forms of embodiment.

FIG. 1 illustrates, in section, a heating, ventilating and/or air conditioning appliance by way of a preferred embodiment of the present invention. This appliance has a fan, not illustrated, which can convey air from the left-hand side so that this air, having been treated by the air treatment devices 10, 12, 14, can be diffused to various air outlet ducts 2, 4, 6. In the form of embodiment illustrated, an air outlet duct 2 is provided for the region of the windshield, an air outlet duct 4 is provided for the region of the air diffusers in the dashboard and an air outlet duct 6 is provided for the region of the feet, the air outlet duct 6 running essentially inward in the plane of the drawing so as to be able to be guided directly past the appliance toward the region of the feet. The heating, ventilating and/or air conditioning appliance illustrated comprises an optional evaporator 10 which may be supplied in its own customary way by a compressor, so as to be able to cool the air supplied by the fan.

From the point of view of the art of fluid mechanics, the evaporator 10 is mounted downstream of a heat exchanger for heating 12, it being possible for an additional heating device 14 to be mounted in parallel with and/or downstream of it. In the embodiment illustrated, the additional heating device 14 is an electric heating device which is made up of what are known as Positive Temperature Coefficient (PTC) resistive elements. As can be seen, the air leaving the evaporator 10 can be fed simultaneously into the heat exchanger for heating 12 and the additional heating device 14, means for controlling the air stream, in the form of butterfly valves and/or shell valves, louvers and the like, although not illustrated, possibly being provided in the region directly adjacent to the evaporator 10, so as to orient the air leaving the evaporator 10 toward the heat exchanger for heating 12 or toward the additional heating device 14, or so as to alter, at least in sections, the supply to the heat exchanger for heating 12 and/or to the additional heating device 14.

As can be deduced from the depiction of FIG. 1, the additional heating device 14 is therefore no longer downstream of the heat exchanger for heating 12 from the point of view of the art of fluid mechanics, but is, on the contrary, located in the path otherwise used for supplying fresh air. The passage of the air through the heat exchanger for heating 12 and/or through the additional heating device 14 is, in the embodiment illustrated, through successive means 30, 40 of controlling the air stream. In the embodiment illustrated, a means 40 of controlling the air stream, in the form of a shell valve, which can, as selected, open or close the cross section behind it (intermediate positions as illustrated also being possible) is located, from the point of view of the art of fluid mechanics, behind the additional heating device 14. The means 30, 40 of controlling the air stream may, in particular, operate like mixing valves, which may also be coupled to one another.

From the point of view of the art of fluid mechanics, two air passages, each of which can be controlled by the means 30, 40 for controlling the air stream, are situated behind the heat exchanger for heating 12. The means 40 of controlling the air stream, which can control the passage of air through the additional heating device 14, makes it possible, as illustrated, to close off the lower cross section of the space connecting with the heat exchanger for heating 12, while the means 30 of controlling the air stream, designed in the form of a butterfly valve, can open or close an upper section of this space. Once air has passed past the means 30 and/or 40 of controlling the air stream, the air treated accordingly can be distributed to the various air outlet ducts 2, 4, 6 by respective means 22, 24, 26 of controlling the air stream, it being possible in particular for different air outlet ducts 2, 4, 6 to be supplied with air treated by respective different air treatment devices 10, 12, 14 or combinations thereof.

By way of illustrative methods of operating the heating, ventilating and/or air conditioning appliance illustrated in FIG. 1, there will be described, on the one hand, a method in which the heat exchanger for heating 12 is still cold, but it is desirable for the mist formed on the windshield to be reduced whereas, on the other hand, there will also be described another method in which the heat exchanger for heating 12 has reached its operating temperature and a higher temperature in the region of the feet than in the region of the dashboard is desired.

In the first method mentioned, the means 30, 40 of controlling the air stream close the space which lies directly behind the heat exchanger for heating 12, so that the air cannot pass through the heat exchanger for heating 12. On the contrary, all the air is guided through the additional heating device 14 and is heated thereby. In as much as the additional heating device 14 in the form of embodiment illustrated is an electric heating appliances, a swift response can be obtained significantly before the engine reaches its operating temperature and, furthermore, in the embodiment illustrated, there is the advantage that no pressure drop is caused by the passage through the heat exchanger for heating 12. Having been heated through the additional heating device 14, the air will pass past the means 40 of controlling the air stream, in the open position that this air path has, and since the means 24, 26 for controlling the air stream are closed, will be guided exclusively toward the air outlet duct 2, which may open directly below the windshield, in order thus to reduce misting, and this will take place before the vehicle engine is able to supply enough thermal power to do this. As the heating power available to the heat exchanger for heating 12 increases, the means 40 of controlling the air stream can be gradually opened and the means 30 of controlling the air stream can be gradually closed.

In the other method of operation mentioned, in which hotter air in the region of the feet and moderately hot air in the region of the diffusers is desired, the means 30 of controlling the air stream may be in the open position, while the means 40 of controlling the air stream blocks the lower section of the space which connects with the heat exchanger for heating 12. Thus, the air is heated up, through the heat exchanger for heating 12, which in this case is at the operating temperature, and is discharged upward. By setting the means 22, 24 and 26 of controlling the air stream accordingly, the air outlet duct is closed in this method of operation, which means that almost all of the air heated up in the heat exchanger for heating 12 is available to the air outlet duct at the feet 6. In as much as the additional heating device 14 can be supplied with air in parallel with the heat exchanger for heating 12, some of the air can be heated by the latter, so as to pass at the open means 40 of controlling the air stream, toward the outlet duct 4, which is also open via its means 24 of controlling the associated air stream.

Obviously, a number of methods of operation may be represented with the arrangement illustrated, the various statuses, particularly of the heat exchanger for heating 12, being able to be taken into consideration. It may be mentioned that, by virtue of the arrangement in parallel, from the point of view of the art of fluid mechanics, of the heat exchanger for heating 12 and at least part or a section of the additional heating device 14, several airflow paths are possible, it being possible for pressure drops on the one hand, and heat losses by heating by radiation of other parts, also to be avoided. Finally, it should also be mentioned that arranging the additional heating device 14 in the path of the air otherwise intended to supply fresh air constitutes no disadvantage to the latter, because the response mode in customary additional heating appliances is swift and the masses involved are low.

FIG. 2 illustrates, in a view similar to FIG. 1, a preferred alternative form of embodiment in which the conventional flow path is represented, on the one hand, with an evaporator, a heat exchanger and an additional heating device mounted in series and, on the other hand, the passage according to the invention through the additional heating device 14 of air which has not passed through the heat exchanger for heating, through corresponding dividing walls and means of controlling the air stream. As in the case of the form of embodiment illustrated in FIG. 1, the heating, ventilating and/or air conditioning appliance of this form of embodiment comprises a fan, not illustrated, an optional evaporator 10 used for air conditioning, and a heat exchanger for heating 12. As in the embodiment illustrated in FIG. 1, three air outlet paths 2, 4, 6 are provided using the respective means 22, 24, 26 of controlling the air stream. As in the embodiment illustrated in FIG. 1, the space connected to the heat exchanger for heating 12 has two means 30, 40 for controlling the air stream, which can open an upper or lower region of this space. The additional heating device 14, is, as in the embodiment illustrated in FIG. 1, in one air path which can supply fresh air or cold air, but is now arranged above the air outlet duct 4.

The form of embodiment illustrated in FIG. 2 makes it possible, in the form of illustrative modes of operation, to supply air heated by the additional heating device to the air outlet path 2, as also permitted by the form of embodiment illustrated in FIG. 1. Unlike the form of embodiment illustrated in FIG. 1, however, other modes of operation are possible, namely, for example, a mode in which the air for the air outlet path 4 is passed in succession over the evaporator 10, the heat exchanger for heating 12 and the additional heating device 14 or, on the other hand, by way of another example, a mode of operation in which both the region of the feet and the region of the windshield are supplied with air heated by the additional heating device 14, while cooled air or fresh air can be sent through the diffusers into the region of the dashboard. Finally, the form of embodiment illustrated also allows a mode of operation in which the air flows partly through the heat exchanger for heating 12 and at the same time through at least part of the additional heating device 14, so as to be mixed via the means 30 of controlling the air stream, so that in this mode the means 30 of controlling the air stream can act as a mixing valve for two differently heated air flows.

The embodiment illustrated in FIG. 3 is an improvement to the form of embodiment illustrated in FIG. 2, the corresponding constituent parts having been described in the previous forms of embodiment being provided with corresponding reference numbers and not being dealt with in detail again. Unlike the form of embodiment illustrated in FIG. 2, the additional heating device 14 no longer runs essentially parallel to the heat exchanger for heating 12 but forms therewith a configuration essentially in the shape of a V, in which, however, instead of the two branches being in contact, there is a space which allows air to pass past the additional heating device 14. In other words, there is thus the possibility, in this form of embodiment, to envisage mounting three air streams in parallel, namely, on the one hand, an air stream which passes through the heat exchanger for heating 12, an air stream which passes through the additional heating device 14 and an air stream which passes through neither air heating device 12 or 14. It must be mentioned in this form of embodiment that, as in the form of embodiment illustrated in FIG. 2, the additional heating device 14 may be traversed by a stream in different directions in different modes of operation. In particular, with the form of embodiment illustrated, which also provides an air outlet duct for the bottom region 6′, it is thus possible by way of example to represent the following modes of operation:

successive heating of the air through the heat exchanger for heating 12 and the additional heating device 14, for diffusion into the bottom region via the outlet duct 6′ or at the dashboard via the outlet duct 4;

heating of the air through a passage in parallel through both the heat exchanger for heating 12 and the additional heating device 14 for diffusion, for example, via the air outlet duct 2 as far as the windshield, it optionally being possible for fresh air to come out in the region of the bottom and/or of the dashboard;

a great many other configurations of air paths are possible and will be readily apparent to the person skilled in the art on examining the figure.

FIG. 4 illustrates an appliance similar to the one illustrated in FIG. 3, except that the additional heating device 14 extends across the entire width of the fresh air path and may be split into different sections by the means 40 of controlling the air stream. The evaporator 10, the heat exchanger for heating 12 and the additional heating device 14 thus form an essentially N-shaped configuration with a multi-functional possibility of guiding the air paths, similar to the modes described regarding the abovementioned forms of embodiment. Although this has not been illustrated, the person skilled in the art will recognize that the additional heating device 14 could also not be as wide, as illustrated for example in FIG. 3, so that it can be moved fore and aft like a slide to allow for example the passage of fresh air giving rise to practically no pressure drop.

In the form of embodiment illustrated in FIG. 5, the additional heating device 14 may be positioned similarly to FIG. 4, possibly by displacement and, in one position, has two sections 14′, 14″ which are not coupled together. With this form of embodiment, it is possible to represent the flow paths through the appliance essentially as has been described taking account of the previous forms of embodiment, it being possible for the air which has not passed through the heater body 12 to be heated up using the additional heating device 14. In addition, this form of embodiment also however makes it possible to supply particularly hot air, for example to the region of the windshield, by passing the air first of all over the heat exchanger for heating 12, then through the first section 14′ of the additional heating device and, after a bend, back through the second section 14″ of the additional heating device 14, in essentially the opposite direction.

FIG. 6 also illustrates another preferred form of embodiment of a heating, ventilating and/or air conditioning appliance according to the invention, in which the additional heating device 14, as in the form of embodiment illustrated in FIG. 1, may lie essentially below or in the direction of the continuation of the heat exchanger for heating 12. In the form of embodiment illustrated here, the additional heating device 14 is arranged so that it can pivot about a median axis, so that, on the one hand, the configuration illustrated essentially in FIG. 1 can be represented whereas, on the other hand, it is also possible to arrange the additional heating device 14 in such a way that it lies essentially in the direction of the existing flow, so that the resistance to flow is markedly reduced.

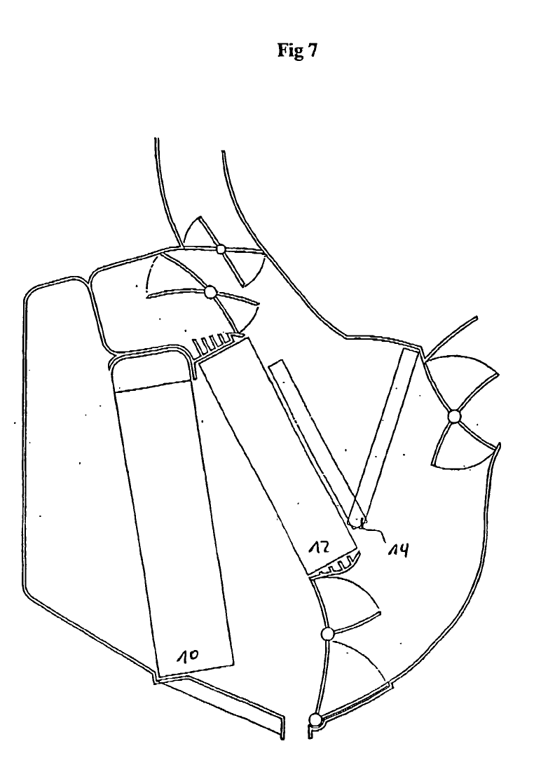

FIG. 7 illustrates a form of embodiment in which the additional heating device 14 is arranged, from the point of view of the art of fluid mechanics, behind the outlet duct 4 so as to be able to pivot between a position in which the additional heating device 14 runs parallel to the heat exchanger for heating 12 practically against it, and a position in which it extends as far as the cold air path and a position in which it runs transversely to the cold air path. This form of embodiment thus makes it possible, on the one hand, in the first position mentioned, to have conventional operation, that is to say with successive passage through the heat exchanger for heating and the additional heating device and, on the other hand, in the second position mentioned, supply in parallel or selectively with air by the additional heating device 14 and the heat exchanger for heating 12.

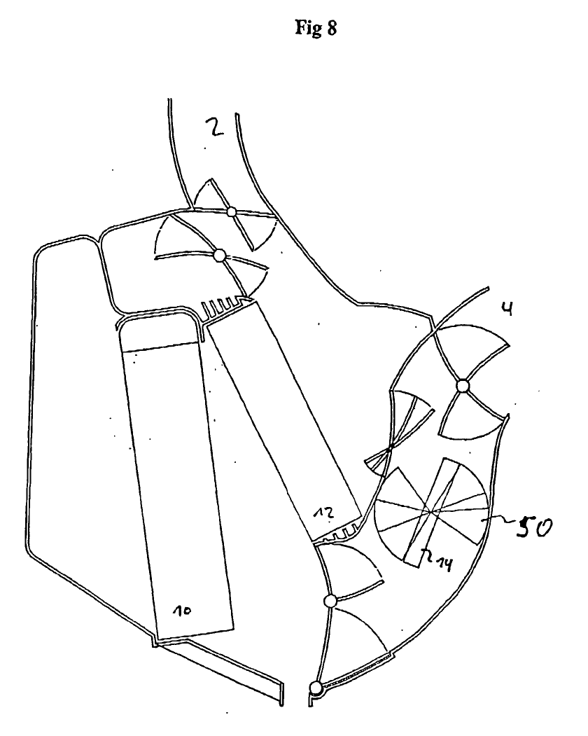

FIG. 8 finally illustrates a preferred form of embodiment in which the additional heating device 14 runs essentially in the direction of the flow in the cold air path. Although in the embodiment illustrated the additional heating device is depicted flat and planar, the person skilled in the art will recognize that a curved or bent configuration may be advantageous. In order to be able to allow the stream to pass as required through the additional heating device, a double shell valve 50 is also provided, and can give rise to the passage of part or all of the air flow through the additional heating device 14.

Overall, it is thus possible, with the forms of embodiment described, to achieve various flow configurations through the appliance, it being possible for the means of controlling the air stream which customarily exists in the appliance to be supplemented as necessary in their use by other means of controlling the air stream. Thus, for example, the control of the air stream means which adopt the function of a mixing valve makes it possible to take account of the heating power available from the heat exchanger for heating, of the external temperature, and of other technical air conditioning parameters, it being possible for the pressure drops that exist in the respective air paths to be optimized according to the mode of operation. For example, in the start-up phase, it is possible to isolate the heat exchanger for heating from the circulation of air so that the air can be brought up to the operating temperature more quickly, whereas the heating power needed can be supplied at least by transition through the additional heating device.

Although this has not been illustrated, it is, for example, also possible, for the operation of the additional heating device to be configured according to the position, for example it would be possible to envisage bringing into contact the additional heating device 14 in the form of embodiment illustrated in FIG. 6 only in the position in which a stream is passed through it. In addition, aside from the movement of pivoting about a median axis, it would also be possible to envisage other movements of some kind, for example about an axis which is off-centered or also a translational movement or a combined pivoting-sliding movement, or even a movement in a direction perpendicular to the respective plane of section of the forms of the embodiment illustrated.

Although the present invention has been described above fully and by way of example with reference to the currently preferred forms of the embodiment, the person skilled in the art will appreciate that very varied variations and modifications are possible within the scope of the claims. In particular, the person skilled in the art will appreciate that the individual characteristics of one form of embodiment can be combined as desired with characteristics of other forms of embodiment, and, in particular, the person skilled in the art will also appreciate that corresponding adaptations may be made according to the type of control, that is to say fluidic or pneumatic control.

1. A heating, ventilating and/or air conditioning appliance, particularly for a vehicle, optionally having an evaporator (10) and comprising a fan, a heat exchanger for heating and an additional heating device (14), in which the additional heating device (14) can be supplied at least partly with air which has not passed through the heat exchanger for heating (12).

2. The heating, ventilating and/or air conditioning appliance as claimed in claim 1, in which the additional heating device (14) can be connected in parallel at least partly with respect to the heat exchanger for heating (12), from the point of view of the art of fluid mechanics.

3. The heating, ventilating and/or air conditioning appliance as claimed in claim 1 or 2, in which the additional heating device (14) is connected in parallel at least partly with respect to the heat exchanger for heating (12), from the point of view of the art of fluid mechanics.

4. The heating, ventilating and/or air conditioning appliance as claimed in any of the preceding claims, in which the additional heating device (14) can actually have at least sections traversed in essentially opposite directions.

5. The heating, ventilating and/or air conditioning appliance as claimed in any of the preceding claims, in which the additional heating device (14) runs essentially parallel to the heat exchanger for heating (12) or essentially at right angles to the direction of flow which would become established therein in the event of failure of the additional heating device (14).

6. The heating, ventilating and/or air conditioning appliance as claimed in any of claims 1 to 5, in which the additional heating device (14) runs essentially at right angles to the heat exchanger for heating (12) or essentially parallel to the direction of flow that would become established therein in the event of failure of the additional heating device (14).

7. The heating, ventilating and/or air conditioning appliance as claimed in any of claims 1 to 5, in which the additional heating device (14) forms, with the heat exchanger for heating (12), a configuration essentially in the form of a V and, in particular in the case that there is an optional evaporator (10) present, forms with the latter and with the heat exchanger for heating (12), a configuration essentially in the form of an N.

8. The heating, ventilating and/or air conditioning appliance as claimed in any of the preceding claims, in which the additional heating device (14) is mounted so that it can move, particularly so that it can pivot between an arrangement essentially parallel and an arrangement essentially at right angles to the heat exchanger for heating (12), or between an orientation essentially at right angles to the heat exchanger for heating (12) and an orientation essentially parallel to a direction of flow of air which would become established therein in the event of failure of the additional heating device (14).

9. The heating, ventilating and/or air conditioning appliance as claimed in any of the preceding claims, in which the additional heating device (14) is an electric heating device, particularly at least one PTC heating element.
